(19) United States
(12) Patent Application Publication
(10) Pub. No.: US 2006/0225969 A1
(43) Pub. Date: Oct. 12, 2006

(54) Method and apparatus for retracting piston actuator by configured clutch plates

(75) Inventors: Frederick A. Lloyd, JR., Crawfordsville, IN (US); Przemyslaw Zagrodzki, West Lafayette, IN (US); Anthony J. Lemela, Gilberts, IL (US)

Correspondence Address: BROOKS KUSHMAN P.C., 1000 TOWN CENTER, TWENTY-SECOND FLOOR, SOUTHFIELD, MI, 48075, US

(73) Assignees: Raybestos Products Company, Crawfordsville, IN (US); CNH America LLC, New Holland, PA (US)

(21) Appl. No.: 11/103,794

(22) Filed: Apr. 12, 2005

(51) Int. Cl. F16D 55/36

(52) U.S. Cl. 188/71.5

(57) ABSTRACT

A method and apparatus for reducing wear in a piston actuated brake or clutch pack assist retraction of the piston by configuring the friction discs. Preferably, a core is shaped with waves that generate axial force during brake release.

### BACKGROUND OF THE INVENTION

1. Field of the Invention

The present invention relates to piston actuated friction packs, including brake packs and clutch packs, in which the friction discs are configured to assist retraction of the piston.

2. Background Art

Attempts have been made to increase brake life by reducing the wear in the rear axle wet brakes of loader/backhoes. Tests performed indicate the wear was higher than normally expected as a result of brake drag, high axle temperatures, and oil film characteristics. Tests have shown that the axle temperatures, and wear, can be significantly reduced by applying a force to retract the piston that actuates the clutch pack. However, hardware solutions add substantial parts, packaging, weight and expense that may not be practical or inexpensively employed in the field.

### SUMMARY OF THE INVENTION

The present invention overcomes the abovementioned disadvantages by using a waved friction disc to accomplish the piston retraction in a friction pack. As used in this disclosure, any reference to a clutch or a brake may be read unrestrictively as referring to any friction pack. Similarly, any recitation of a clutch plate or a brake plate, may be read unrestrictively throughout the specification and claims as any friction disc without limitation. In the preferred embodiment, a waved version of a current production friction disc was analyzed initially using finite element method. The purpose of this analysis was to determine the stiffness characteristics of the plate during disengagement and the contact pressure variations at the contact interfaces during engagement.

The stiffness characteristic of the disc is defined as the relationship between the axial force and the axial displacement when the disc is subjected to axial compression between two parallel surfaces. The stiffness characteristic determines the force with which the pack pushes the piston back as a function of axial deflection of the pack or piston travel.

Pressure variation across the contact interface is an undesired side effect of disc waviness. In this analysis, an attempt is made to find the configuration, including wave shape and magnitude, that would produce sufficiently high spring force with minimal pressure variation at the contact interface. Examples of variations in plate geometries tested are summarized in Table 1. Other features of the plate geometry including friction layer shaping may also be developed without departing from the present invention.

TABLE 1

| | | | | Wave Height | |
|---|---|---|---|---|---|
| Item # | # of Slots | Connected | # of Waves | inches | mm |
| 1 | 5 | no | 5 | 0.008 | 0.2 |
| 2 | 5 | no | 5 (mod) | 0.008 | 0.2 |
| 3 | 5 | yes | 5 | 0.008 | 0.2 |
| 4 | 6 | yes | 6 | 0.008 | 0.2 |
| 5 | 6 | no | 6 | 0.008 | 0.2 |
| 6 | 6 | yes | 3 | 0.012 | 0.3 |

### BRIEF DESCRIPTION OF THE DRAWINGS

The present invention will be more clearly understood by reference to the following detailed description of the preferred embodiment when read in conjunction with the accompanying drawing in which like reference characters refer to like parts throughout the views and in which:

FIG. 1 is a fragmented sectional view of a prior art brake pack to which the invention may be applied;

FIG. 2 is an enlarged, broken, perspective view of a sector of a prior art brake disc for use in the pack of FIG. 1, the disc being composed of several contiguous sectors;

FIG. 3 is an enlarged, broken, perspective view similar to FIG. 2, but showing an embodiment of a piston retracting brake disc configuration (not to scale) according to the present invention;

FIG. 4 is an enlarged, broken perspective view showing the segment of FIG. 3 rotated to clarify the appearance of the plate configuration (not to scale) according to the present invention;

FIG. 5 is a sectional view, not to scale, to emphasize the taper that would be seen from a section taken substantially along the line 5-5 in FIG. 4;

FIG. 6 is a graphic representation of the stiffness characteristics of several embodiment models evaluated throughout the full range of engagement and disengagement of the brake pack according to the present invention;

FIG. 7 is an enlarged, graphic representation of a portion of FIG. 6, emphasizing the forces nearer the disengaged displacement of the friction pack;

FIG. 8 is a graphic representation of displacement corresponding to a selected drop of spring force for the embodiment referred to in FIG. 6;

FIG. 9 is a graphic representation of displacement corresponding to an alternative selected drop of spring force for the embodiments referred to in FIGS. 6-8; and

FIGS. 10-14 show pressure distribution on items identified in Table 1.

### DETAILED DESCRIPTION OF THE PREFERRED EMBODIMENT(S)

As shown in FIG. 1, a brake assembly 20, includes a plurality of friction discs 22, reaction plates 28, end plate 34 and an actuator such as piston 31. Each disc 22 has at least one friction layer 26 applied to core 27 at a position adjacent a reaction plate 28. The discs 22 and reaction plates 28 are arranged in a friction pack 24 and alternately connected, for example by splines, for rotation with a hub and a housing, respectively, in a well known manner. A piston 31 slides (to the right in FIG. 1) toward the end plate 34 to engage the brake by compressing the friction discs 22 with the friction layers 26 against the reaction plates 28. Conversely, the brake is released as the friction pack 24 is disengaged as the piston 31 is displaced (to the left in FIG. 1) away from end plate 34.

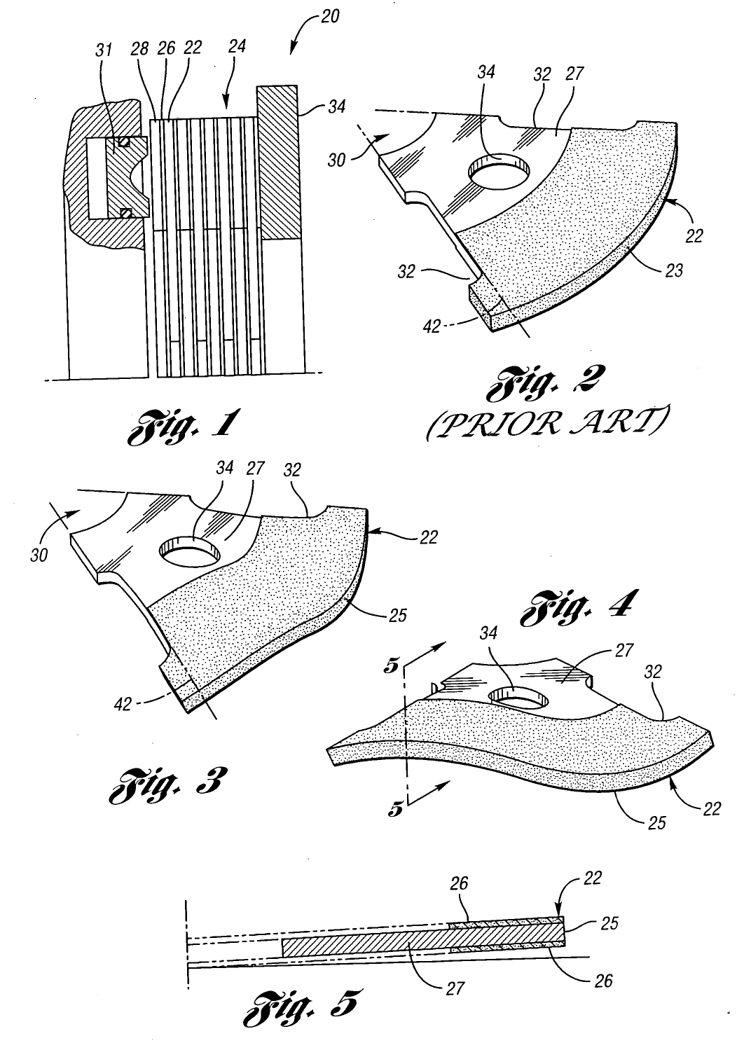

Referring now to FIG. 2, the friction discs 22 have a geometry with sectorially symmetric sides, with several sectors 30 (one shown) of the annular plate determined by radial slots 32 and circular holes 34 regularly distributed around circumference. A three-dimensional finite element model of the plate was developed in which sectorial symmetry was utilized. However, the discs may differ as slots or holes or both may be omitted without departing from the invention. However, the prior art disc was made of a flat core 23.

Lack of clearance in a disengaged brake pack was hypothesized to be a major cause of these problems. Insufficient clearance deteriorates oil flow between the friction disc and reaction plate, causing brake drag and contributing to high axle temperature. All of these factors contribute to increased wear.

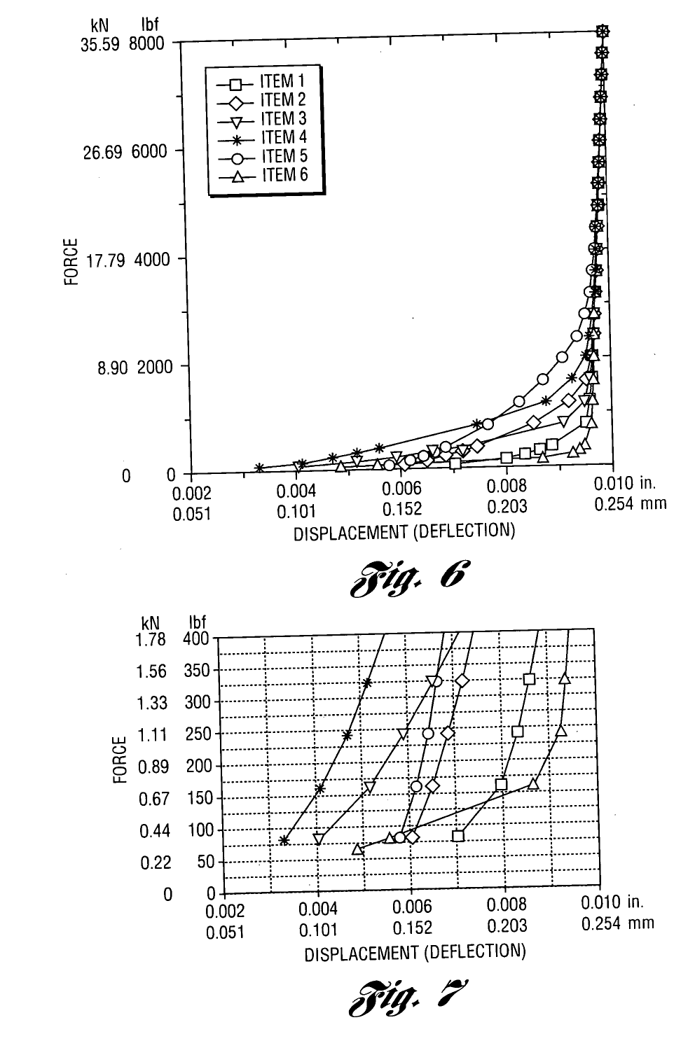

Selection of the wave configuration is made based on a compromise of having sufficient force to push back the piston during the disengaged condition and minimizing the maximum localized pressure at the friction interface during the engaged condition. A new configured disc is shown in FIGS. 3 and 4 to form the friction disc 22 by waving the core 25 before or after applying the friction layer 26. Two basic designs were considered: a design with five fins (sectors) 30 and alternative design with six fins 30, although the number may be changed without departing from the invention. Within each of these designs a version with connected fins as well as disconnected fins, where radial slots 32 reach outer disk perimeter as shown at 42, were analyzed. Different shapes and magnitudes of waviness may be applied to provide the configured core 25 to be tested as friction discs 22.

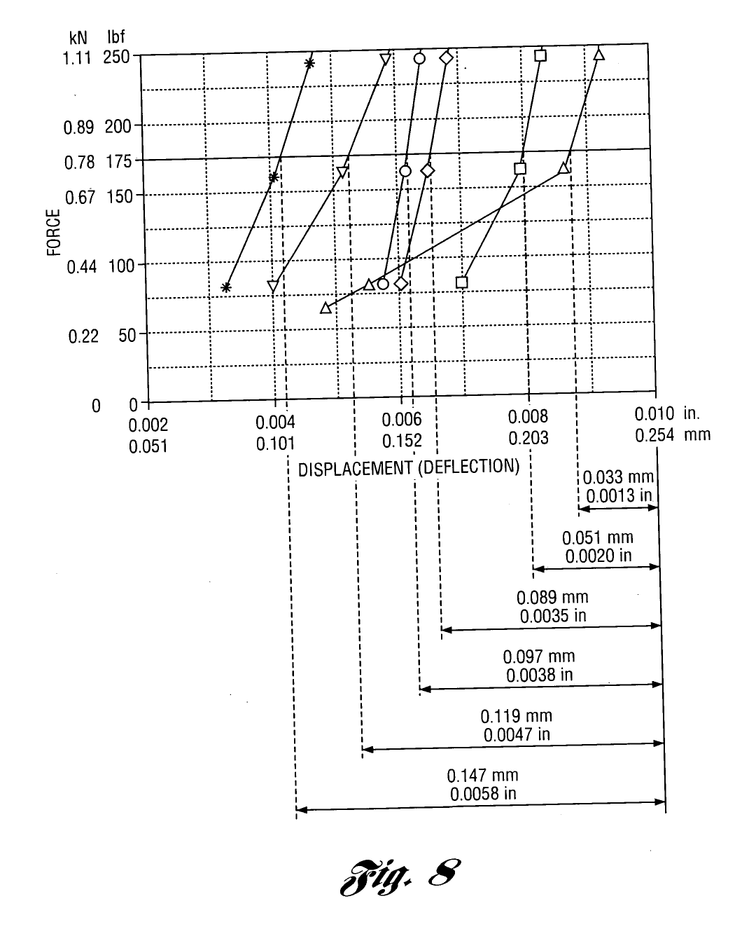

The sectors 30 of waved core 25 may be sinusoidal in the circumferential direction (FIG. 4) and may be tapered in the radial direction with the maximum wave amplitude at the outer perimeter and zero amplitude at the center of the disc (FIG. 5). In the case of the disc with five fins, five full waves around the circumference were used with the sinusoid starting in the center of a slot 32. In a disc with five disconnected fins, an additional modified sinusoid version was considered (item 2 in Table 1); which was a wavelength longer than that indicated by the angular length of the fin and therefore it is symmetrically trimmed on both ends. With five fins (items 1 and 3), the full sinusoid covers 72° whereas the modified sinusoid has a wavelength of 96°.

In the disc with six fins, six full sinusoidal waves (items 4 and 5 in Table 1) as well as three sinusoidal waves (item 6 in Table 1) around the circumference were considered. The wave height as listed in Table 1 is defined as twice the amplitude of the sinusoid. The wave heights for items 1-5 was 0.2 mm (0.008 inches). For the disc with six fins and three waves (item 6), a wave height of 0.3 mm (0.012 inches) was used as this disc exhibited relatively compliant spring characteristic.

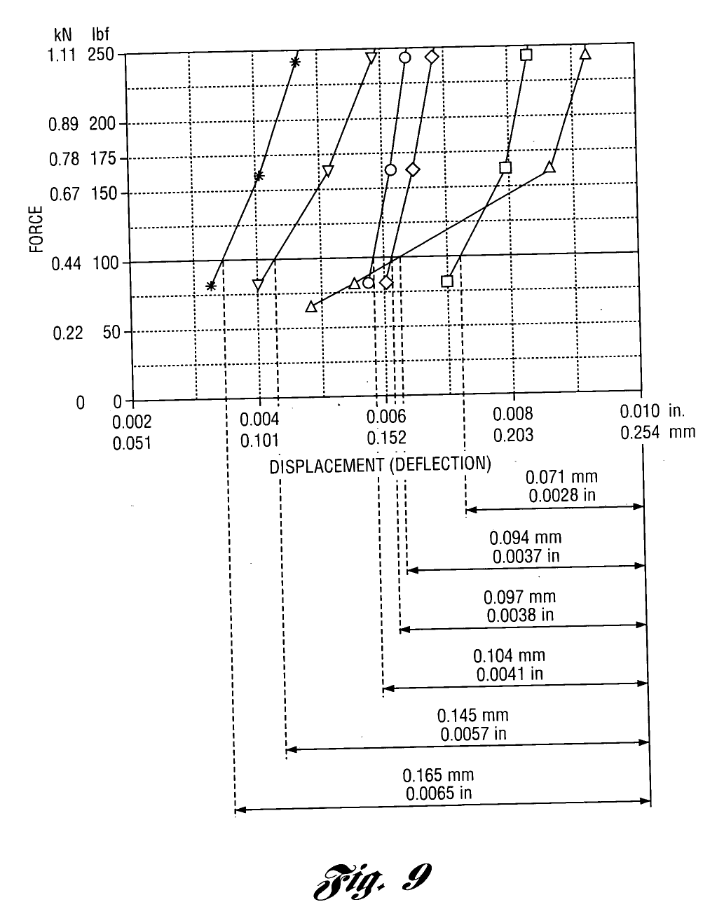

In the finite element simulation the axial force was ramped from zero to a force of 34.1 kN (7,670 lb-f) that corresponds to the line pressure in the brake application system of around 2.76 MPa (400 psi). FIG. 6 shows the stiffness characteristics of the various plate geometries analyzed over the applied pressure range 0 to 2.76 MPa (400 psi). FIGS. 7-9 shows these stiffness characteristics in a scale that is more helpful in this analysis. In FIGS. 8 and 9, these characteristics are then used to determine the plate displacement on unloading the plate from the axial force corresponding to line pressure of 2.76 MPa (400 psi) to the point when the axial force drops to 0.78 kN (175 lb-f) and 0.44 kN (100 lb-f), respectively. These two values are representative of the range of the piston resistance force reported by the vehicle manufacturer, and other ranges or limits may apply in other instances without departing from the invention. The displacements determined from the characteristics are summarized in Table 2.

TABLE 2

| | | | | | Maximum Localized | |
|---|---|---|---|---|---|---|
| | | | | | Pressure With a Line | |
| | Displacement at | | Displacement at | | Pressure of 2.76 MPa | |
| | 0.78 kN (175 lbf) | | 0.44 kN (100 lbf) | | (400 psi) | |
| Item # | mm | in | mm | in | MPa | psi |
| 1 | 0.051 | 0.0020 | 0.071 | 0.0028 | 5.288 | 767 |
| 2 | 0.089 | 0.0035 | 0.097 | 0.0038 | 4.449 | 645 |
| 3 | 0.119 | 0.0047 | 0.145 | 0.0057 | 5.050 | 732 |
| 4 | 0.147 | 0.0058 | 0.165 | 0.0065 | 6.537 | 948 |
| 5 | 0.097 | 0.0038 | 0.104 | 0.0041 | 6.701 | 972 |
| 6 | 0.033 | 0.0013 | 0.094 | 0.0037 | 3.353 | 486 |

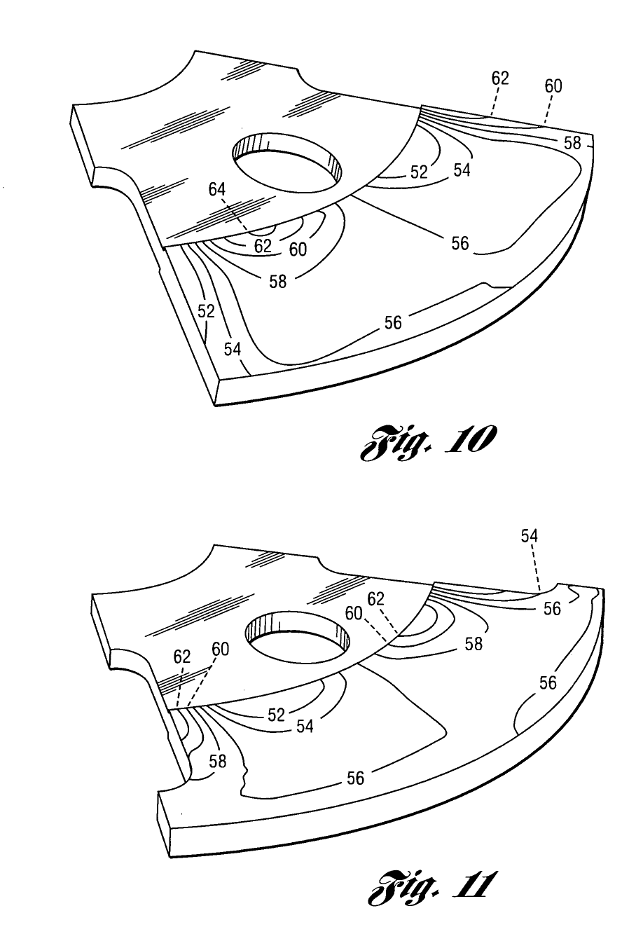

FIGS. 10-14 show pressure distribution lines 52-66 on contact interfaces when the force corresponding to line pressure of 2.76 MPa (400 psi) is applied to items 1 and 3-6. The distribution lines 52-66 designate constant pressures shown in Table 3.

TABLE 3
LEGEND

| | MPa | psi |
|---|---|---|
| 52 | 0.34 | 50 |
| 54 | 0.69 | 100 |
| 56 | 1.03 | 150 |
| 58 | 1.38 | 200 |
| 60 | 1.72 | 250 |
| 62 | 2.07 | 300 |
| 64 | 2.41 | 350 |
| 66 | 2.76 | 400 |

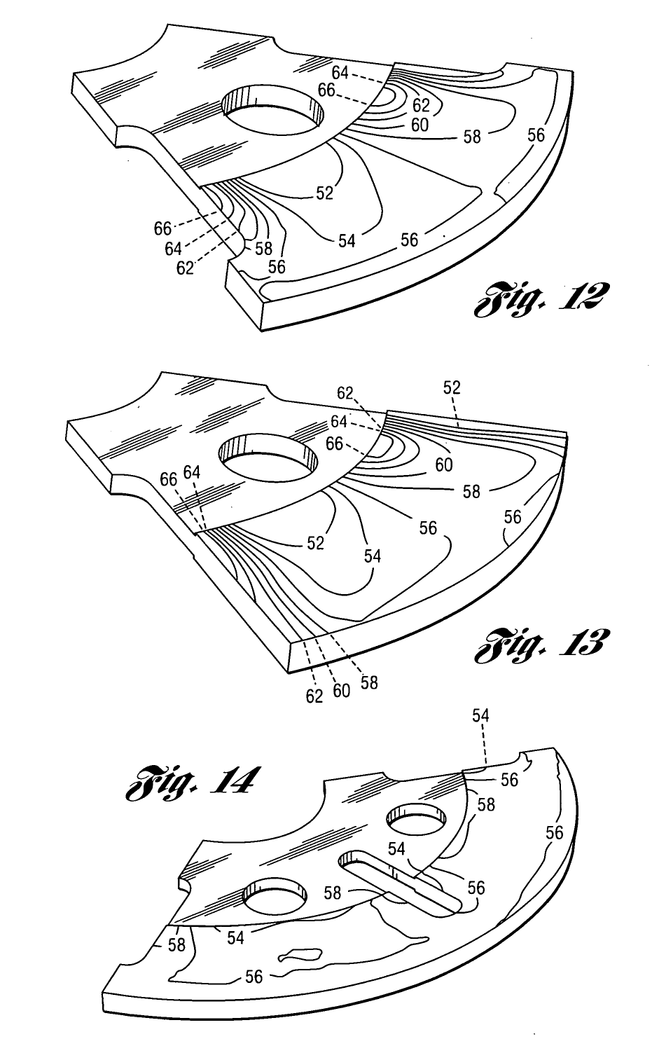

The most uniform contact pressure was obtained with the disc with six fins and three waves around the circumference (item 6 in Table 1), FIG. 14. However, the return force for that disc drops quickly upon plate unloading, as shown in FIGS. 7 and 8, and a very small piston displacement is obtained at the axial force of 0.78 kN (175 lb-f). The disc with five disconnected fins (item 1 in Table 1) has similar contact pressure variation to the disc with five connected fins (item 3 in Table 1). The disc with the connected fins, however, provides higher return force as shown in FIGS. 7 and 8. Discs with six fins ans six waves have the stiffest characteristics and provide high return force. The pressure variations for those discs (FIGS. 12 and 13) are, however, unacceptably strong. The maximum pressures as determined in finite element simulations are included in Table 2.

From the evaluation, the ability of the waved friction disc in the clutch pack assembly to push back the piston increases as the number of waves and wave height on the part increases. The ability of the waved friction assembly to push back the piston increases when the slots are connected, that is, when the slots do not extend to the radially outer disk perimeter. The pressure distribution during engagement improves as the number of waves decreases.

The advantage of Item 3 was a robust push back displacement between the 0.44 kN (with a corresponding deflection of 0.145 mm) and 0.78 kN (with a corresponding deflection of 0.119 mm) piston force requirements. Item 6 has the best pressure distribution (3.35 MPa=486 psi max pressure) of all combinations evaluated, but its push back displacement may not be sufficient at higher piston force requirements. Item 1 was lower in push back displacement relative to item 3. Item 2 may raise some disadvantage because discontinuous sinusoidal waves may pose manufacturing challenges. Items 4 and 5 exhibited high localized pressure, higher than may be acceptable in a loader rear axle brake. However, depending upon other factors assisting retraction of the piston, for example, the number of configured disks in the clutch pack or waved disk positioning in the clutch pack, the variations may find utility in practicing the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for retracting a piston actuator for a friction pack having a plurality of friction discs, the method comprising:
configuring at least one friction disc with a wave.

2. The invention as described in claim 1 wherein said at least one friction disc includes a plurality of openings and wherein said configuring comprises peaking said wave intermediate adjacent openings in said disc.

3. The invention as described in claim 1 wherein said configuring includes aligning said wave circumferentially around said at least one friction disc.

4. The invention as described in claim 1 wherein said configuring includes tapering said wave radially across said at least one friction disc.

5. The invention as described in claim 3 wherein said aligning said wave includes cycling at least three phases.

6. The invention as described in claim 5 wherein said cycling includes at least five phases.

7. The invention as described in claim 2 wherein said openings include slots, and cycling said wave in a plurality of phases corresponding in number to a fraction or multiple of a number of said slots.

8. A friction pack for engagement by a piston that improves retraction of the piston comprises:
at least one friction dis configured with a wave,
an end plate, and
a piston actuator for displacing said at least one friction disc toward said end plate.

9. The invention as described in claim 8 wherein said friction disc includes a plurality of openings and wave peaks intermediate adjacent openings.

10. The invention as described in claim 8 wherein said wave is aligned circumferentially around said at least one friction disc.

11. The invention as described in claim 8 wherein said wave is tapered radially across said at least one friction disc.

12. The invention as described in claim 10 wherein said wave cycles through at least three phases.

13. The invention as described in claim 12 wherein said wave cycles through at least five phases.

14. The invention as described in claim 9 wherein said openings include slots and said wave cycles through a plurality of phases corresponding in number to a fraction or multiple of a number of said slots.
